(19) United States
(12) Patent Application Publication
(10) Pub. No.: US 2014/0236735 A1
(43) Pub. Date: Aug. 21, 2014

(54) DISPLAYING AMOUNT PAID TO WEBSITE IN USER PROFILE

(71) Applicant: Qiang Du, (US)

(72) Inventor: Qiang Du, Mountain View, CA (US)

(21) Appl. No.: 13/770,810

(22) Filed: Feb. 19, 2013

(51) Int. Cl. G06Q 30/02; G06Q 50/00

(52) U.S. Cl. CPC G06Q 30/0273; G06Q 50/01
USPC 705/14.68

(57) ABSTRACT

Systems and methods are provided for increasing sponsorship amounts paid in connection with displaying content, such as increasing amounts paid by members to social networks and amounts paid by advertisers to search engines and other websites. According to embodiments, a sponsorship program can be used to highlight the wealth and dedication that some entities have by publishing the amounts those entities paid in connection with the content.

### BACKGROUND

The internet contains too much information for one individual to consume. For example, the internet contains a large number of social networking websites and, with the expansive information already available on the internet, it is nearly impossible to consume the information from all of the user profiles on the social networking websites. Some of these social networking websites are used to maintain contact with people that users already know. Other social networking websites are directed toward maintaining business relationships. Some social networking websites are directed toward establishing new relationships with persons who are not yet known to the user. This third type of social networking website can be generically referred to as a dating website. Dating websites typically serve the purpose of matching persons previously unknown to each other for purposes of establishing relationships.

To learn more about other users, dating websites can post relevant information in a profile to advertise users to other users. However, like the internet in general, dating websites can have too many profiles for users to easily and quickly sort through to find their match. In particular, some of the more wealthy users may want to attract others users, especially attraction from the users that appreciate wealth, but can get lost in the multitude of other users on the social networking website who may not be as wealthy.

The internet also contains a lot of advertisements. The advertisements can be displayed in various locations throughout the internet, including in a list of search results provided by search engines. Particularly, search engines can display advertisements related to a variety of backgrounds and topics. Like profiles on dating websites, advertisements are provided frequently, and can be lost with a multitude of other advertisements. The advertisements become less effective to the users, when users have too many advertisements to sort through and cannot clearly delineate the best advertisements from the most dedicated companies from other advertisements presented by the webpage.

In fact, advertisements flood nearly every aspect of everyday life, including television, newspapers, and outdoor advertisement. There are so many advertisements, that consumers have no easy way to delineate the best advertisements from the most dedicated companies.

Embodiments of this disclosure address these and other problems individually and collectively.

### SUMMARY OF THE INVENTION

Systems and methods are provided for increasing sponsorship amounts paid in connection with displaying content, such as increasing amounts paid by members to social networks and amounts paid by advertisers to search engines and other websites. According to embodiments, a sponsorship program can be used to highlight the wealth and dedication that some entities have by publishing the amounts those entities paid in connection with the content. One example of such a sponsorship program involves publishing in a user's online profile a sponsorship amount that user paid in connection with his or her membership to a social networking website, thereby highlighting that user's wealth and dedication to being a member of the social networking website. According to this example, the social networking website may prioritize or otherwise give preference to users' online profiles according to sponsorship amounts paid during particular timeframes. In another example, a search engine may display a sponsorship amount paid by a sponsor in a sponsored search result. In yet another example, a website may display a sponsorship amount paid by the sponsor in an advertisement. As used herein, the terms “webpage” and “website” may be used interchangeably without diverting from the scope of the invention. In still another example, a television, newspaper, internet video (e.g., a video provided by YouTube®), or outdoor advertising (e.g., billboards) may display the sponsorship amount paid by the sponsor in an advertisement.

One embodiment of the present disclosure is directed to a method of displaying a sponsorship amount in a list of search results on a website associated with a social network. The method can comprise inviting users of the social network to pay the sponsorship amount to a social network administrator, the sponsorship amount to be displayed in users' profiles so that each user of the social network can see the sponsorship amount that the users in the social network are willing to pay to the social network administrator to attract other users to their profile; receiving from a first user of the social network a first sponsorship amount, wherein the first sponsorship amount is associated with a first monetary value that the first user is willing to pay to the social network administrator during a first timeframe to attract other users to the first user's profile; updating the first user's profile with the first sponsorship amount; receiving from a second user of the social network a second sponsorship amount, wherein the second sponsorship amount is associated with a second monetary value that the second user is willing to pay to the social network administrator during a second timeframe to attract other users to the second user's profile, wherein the second sponsorship amount is greater than the first sponsorship amount, and wherein the second timeframe shares at least a subset of time in common with the first timeframe; updating the second user's profile with the second sponsorship amount; generating a top sponsor notification message that will notify the first user that the second sponsorship amount is greater than the first sponsorship amount, wherein the top sponsor notification message includes the second sponsorship amount, and wherein the top sponsor notification message identifies the second user as a top sponsor; transmitting the top sponsor notification message to the first user; when the first user's profile and second user's profile are included in the list of search results on the webpage associated with the social network, displaying the second user's profile above the first user's profile, wherein the first user's profile shows the first sponsorship amount, wherein the second user's profile shows the second sponsorship amount, and wherein displaying the second user's profile above the first user's profile attracts other users to the second user's profile; and identifying the second user's profile as the top sponsor in the list of search results on the website associated with the social network.

The method may comprise inviting users of the social network to become reoccurring sponsors so that the sponsorship amount will be received from the user without a subsequent invitation to the user to pay the sponsorship amount. The first timeframe and the second timeframe can be one month. The method may comprise initiating a first payment transaction for the first monetary value associated with the first sponsorship amount; and initiating a second payment transaction for the second monetary value associated with the second sponsorship amount. After the initiating a first payment transaction for the first monetary value, the method may deduct the first monetary value associated with the first sponsorship amount from an account associated with the first user. The method may comprise storing, in a database, the first sponsorship amount and the second sponsorship amount.

Another embodiment of the present disclosure is directed to a system comprising a computer readable medium comprising code executable by a processor for implementing a method of displaying a sponsorship amount in a list of search results on a webpage associated with a social network, the method comprising: inviting users of the social network to pay the sponsorship amount, the sponsorship amount to be displayed in users' profiles so that each user of the social network can see the sponsorship amount that the users in the social network are willing to pay to attract other users to their profile; receiving from a first user of the social network a first sponsorship amount for a first timeframe; updating the first user's profile with the first sponsorship amount; receiving from a second user of the social network a second sponsorship amount for a second timeframe, wherein the second sponsorship amount is greater than the first sponsorship amount, and wherein the second timeframe shares at least a subset of time in common with the first timeframe; updating the second user's profile with the second sponsorship amount; when the first user's profile and second user's profile are included in the list of search results on the webpage associated with the social network, displaying the second user's profile and the first user's profile in the list of search results, wherein the first user's profile shows the first sponsorship amount, wherein the second user's profile shows the second sponsorship amount; and identifying the second user's profile as a top sponsor in the list of search results on the webpage associated with the social network.

The sponsorship amount may be paid to a social network administrator. The first sponsorship amount may be associated with a first monetary value that the first user is willing to pay to the social network administrator during the first timeframe to attract other users to the first user's profile, and wherein the second sponsorship amount is associated with a second monetary value that the second user is willing to pay to the social network administrator during the second timeframe to attract other users to the second user's profile. The second user's profile may be displayed above the first user's profile, and wherein displaying the second user's profile above the first user's profile attracts other users to the second user's profile. The method associated with the system may further comprise generating a top sponsor notification message that will notify the first user that the second sponsorship amount is greater than the first sponsorship amount, and wherein the top sponsor notification message identifies the second user as the top sponsor; transmitting the top sponsor notification message to the first user. The top sponsor notification message can include the second sponsorship amount. The computer readable medium may be coupled with a database, wherein the database stores the first sponsorship amount and the second sponsorship amount. The first timeframe and the second timeframe are one month.

Yet another embodiment of the present disclosure is directed to a method of displaying a sponsorship amount in an advertisement on a webpage, the method comprising: inviting sponsors to pay the sponsorship amount to a webpage administrator, the sponsorship amount to be displayed in the sponsor's advertisement so that each user of the webpage can see the sponsorship amount that sponsors are willing to pay to the webpage administrator to attract users to their advertisement; receiving from a first sponsor a first sponsorship amount, wherein the first sponsorship amount is associated with a first monetary value that the first sponsor is willing to pay to the webpage administrator during a first timeframe to attract users to the first sponsor's advertisement; updating the first sponsor's advertisement with the first sponsorship amount; receiving from a second sponsor of the webpage a second sponsorship amount, wherein the second sponsorship amount is associated with a second monetary value that the second sponsor is willing to pay to the webpage administrator during a second timeframe to attract users to the second sponsor's advertisement, wherein the second sponsorship amount is greater than the first sponsorship amount, and wherein the second timeframe shares at least a subset of time in common with the first timeframe; updating the second sponsor's advertisement with the second sponsorship amount; generating a top sponsor notification message that will notify the first sponsor that the second sponsorship amount is greater than the first sponsorship amount, and wherein the top sponsor notification message identifies the second sponsor as a top sponsor; transmitting the top sponsor notification message to the first sponsor; when the first sponsor's advertisement and second sponsor's advertisement are included on the webpage, displaying the second sponsor's advertisement and the first sponsor's advertisement on the webpage, wherein the first sponsor's advertisement shows the first sponsorship amount, wherein the second sponsor's advertisement shows the second sponsorship amount; and identifying the second sponsor's advertisement as the top sponsor on the webpage.

The first sponsor's advertisement and second sponsor's advertisement can be included in a list of search results on the webpage, and the webpage can be associated with a search engine. The second sponsor's advertisement can be displayed above the first sponsor's advertisement, wherein displaying the second sponsor's advertisement above the first sponsor's advertisement attracts users to the second sponsor's advertisement. The method may further comprise inviting sponsors to become reoccurring sponsors so that the sponsorship amount will be received from the sponsors without a subsequent invitation to pay the sponsorship amount. The method may further comprise initiating a first payment transaction for the first monetary value associated with the first sponsorship amount; and initiating a second payment transaction for the second monetary value associated with the second sponsorship amount. After the initiating a first payment transaction for the first monetary value, the method may further comprise deducting the first monetary value associated with the first sponsorship amount from an account associated with the first sponsor.

Systems and non-transitory computer readable medium embodying the invention are also disclosed.

### BRIEF DESCRIPTION OF THE DRAWINGS

FIG. 1 depicts a block diagram of a dating website system, according to an embodiment.

FIG. 2 depicts browsing user profiles, according to an embodiment.

FIG. 3 depicts browsing search results on a search engine, according to an embodiment.

FIG. 4 depicts a block diagram of a system for implementing the dating website system, according to an embodiment.

FIG. 5 depicts an exemplary screenshot of a profile database, according to an embodiment.

FIG. 6(a) depicts an exemplary screenshot of a sponsorship database, according to an embodiment.

FIG. 6(b) depicts an exemplary screenshot of a transaction database, according to an embodiment.

FIG. 7 depicts an exemplary screenshot of an enrollment website, according to an embodiment.

FIGS. 8(a-b) depicts screenshots of enabling notifications, according to an embodiment.

FIGS. 9(a-c) depict screenshots of receiving notifications after establishing a new top sponsor, according to an embodiment.

FIG. 10 depicts a high level flow chart of a sponsoring process associated with a social networking website, according to an embodiment.

FIG. 11 depicts a high level flow chart of a sponsoring process associated with an advertisement on a website, according to an embodiment.

FIG. 12 shows a block diagram of a computing system, according to an embodiment.

### DETAILED DESCRIPTION

In the following description, for purposes of explanation, specific details are set forth in order to provide a thorough understanding of embodiments of the disclosure. However, it will be apparent that embodiments of the disclosure may be practiced without these specific details.

Embodiments of the present disclosure provide systems and methods for displaying a sponsorship amount in a list of search results on a website associated with a social network, such as dating websites. Dating websites typically have a population of users who are seeking each other out for purposes of companionship, friendship, romance, marriage, or any number of other reasons. Users may want to become more noticeable to other users, and may sponsor a particular timeframe. By sponsoring a timeframe, the user can pay a monetary value to the social network administrator so that the user's profile can be highlighted by the social network as a sponsor. For the remainder of the disclosure, a top sponsor may be a user who provides the most sponsorship (e.g., the most amount of money) for the timeframe. The sponsorship amount need not be entirely financial, as the sponsorship may operate with anything of value.

For example, the social network may invite users of the social network to provide a sponsorship amount to the social network administrator, and, in response to the invitation, one of the users may pay $100 or so to be a sponsor for a period, such as for the month of December. In this example, the user would be considered a sponsor for the month of December and, because no other users sponsored the month of December, the user would also be known as the top sponsor for the month of December. However, this may not always be the case because more than one user may want to sponsor the month of December. When two or more users want to sponsor the same period, all users would be highlighted as sponsors and the user who provides a highest monetary value for sponsorship would be the top sponsor. For example, if a first user pays $100 and a second user pays $200, the first user would be a sponsor and the second user would be a top sponsor.

The user profiles associated with sponsors may be highlighted and sorted into a particular order. For example, when a user's profile is included in a list of search results on a website associated with the social network, the user profiles associated with the sponsorship amount at the time the list of search results is provided may be placed at the top of the list. These profiles may be placed above other users who are not sponsors, or otherwise highlighted so that these profiles stand out from other profiles whose users are not sponsors. The user's profile who is a top sponsor may be placed at the very top of the list, or otherwise highlighted so that the user associated with this profile further stands out from the other sponsors and other users. In an embodiment, the users can search other users based on how much sponsorship other users pay or have spent if there are a lot of sponsors.

The sponsorship amount can further differentiate the sponsors because the sponsorship amount could be displayed with the sponsors' profiles. By sponsoring for a particular amount, other users can see how much a particular user paid for the top spot on the list. The sponsorship amount can highlight the sponsor's privilege, wealth, and dedication to the social network. In an embodiment, the total sponsorship amount spent over time can be displayed with the sponsors' profiles.

In some embodiments, the sponsorship month may not be a month. For example, the sponsorship month can be a timeframe during December 1-31 that happens to coincide with a particular month. When the first user pays $100 on December 1, this user's sponsorship timeframe could be December 1-31 and this user would be top sponsor until another user sponsors a higher amount. When the second user pays $200 on December 10, the second user's sponsorship timeframe could be December 10 to January 9. Because $200 is obviously more money than $100 and a subset of time in each timeframe overlaps (December 10 to December 31), the first user would be top sponsor during December 1-9, and then the second user would be top sponsor starting December 10. The first user would be a sponsor, but not a top sponsor, during December 10-31, when first user's sponsorship period ends. If no other users pay a higher sponsorship amount, the second user would be the top sponsor during December 10 to January 9.

A top sponsor notification message may be sent. For example, when the first user is a top sponsor during December 1-9 and the second user is a top sponsor starting on December 10, the first user may receive a top-sponsor notification that notifies the first user that he or she is no longer the top sponsor. The top-sponsor notification message can include the first user's original sponsorship amount (e.g., $100), second sponsorship amount (e.g., $200), identification of the user who currently holds the top sponsorship title, and the like. The top-sponsor notification message can also include a link for the first user to submit more sponsorship and potentially regain the top sponsor title.

In some embodiments, the sponsorship amount may be provided beyond the context of a social network environment. For example, sponsorship amount may be applied in the broad context of online advertising, such as displaying sponsorship amount in an advertisement, displaying the sponsorship amount in an online video (e.g., a video provided on YouTube®), or in a list of search results on a search-result website generated by the search engine. For example, Beta Search Engine may invite Acme Appliances to pay a sponsorship amount in order to highlight Acme Appliances' advertisement. If Acme Appliances wants to highlight its advertisement in a list of search results on a website associated with the search engine, Acme Appliances can pay a particular sponsorship amount to the administrator. The administrator can highlight the advertisement as a sponsored advertisement and display the amount of money that Acme Appliances paid to the administrator associated with Beta Search Engine in order to have its advertisement highlighted.

In another example, embodiments of the invention can be found outside the context of the internet. For example, the sponsorship amount may be displayed in relation to any medium that is being sponsored, including television advertisements, newspapers, and outdoor advertising.

Embodiments of the invention provide numerous advantages. For example, by displaying the sponsorship amount with the social network profile or advertisement, users who see the sponsored content may be more interested in that content. The sponsorship amount can show the user's privilege and dedication to the social network or advertisement. The sponsorship amount can allow the sponsors and top sponsors to boast or show off their wealth. When more than one user has sponsored content, it can be beneficial to know how much more sponsorship has been paid. For example, when an unknown company has paid twice the amount of money as a well-known company for an advertisement, users may be more inclined to learn more about the unknown company.

Embodiments of the invention also advantageously differentiates online advertisements in a search engine, especially when the consumer searches for a keyword. By displaying the sponsorship amount, large companies can differentiate themselves from smaller companies, to show clear differences between the companies that want to pay more for the keyword. The dedication from the company can also make it easier for the consumer to choose from several companies associated with the keyword to make searching more efficient.

Embodiments of the invention that are applied to television and newspapers also provide numerous advantages. For example, consumers may be more inclined to watch advertisements on television if the consumer knew how much the company spent on the advertisement, like a Super Bowl® commercial. Embodiments of the invention are advantageous because the amount paid for the advertisement is directly and explicitly provided to the consumer/viewer. For example, the amount paid for the advertisement is displayed in the advertisement itself. This information about money and the amount paid for the advertisement will attract the attention of many viewers/consumers.

In yet another advantage, outdoor advertising may be enhanced by embodiments of the invention, because advertisements that display the amount paid for the advertisement may seem less boring and attract consumers' attention. For some, consumers may form the habit of counting the sponsorships and money when viewing the advertisements displayed online, on television, in newspapers, on outdoor billboards and signs, etc. Consumers generally may also appreciate higher costs of advertisements from companies that attempt to woo them.

It could also be beneficial for the administrator to publish the sponsorship amount. For example, when a company owns a trademark, other companies may not be able to purchase locations in a list of search results related to that trademark. This may cause the value of the trademarked search term to diminish, and the company may only be willing to pay a small amount of money for the search term. By publishing a small sponsorship amount that a large company paid for a particular trademark term (e.g., $0.01), the large company may be shamed or feel obligated to pay more for the term. This may create more revenue for the administrator.

Further, embodiments of the invention can display the total sponsorship amount paid over time. For example, total sponsorship amount can be the total amount the company has paid for advertising in the preceding year, month, etc., the amount the company has paid since the inception of that particular advertisement or campaign, etc. This is also advantageous because the administrator may use this to impress consumers and reward loyal clients.

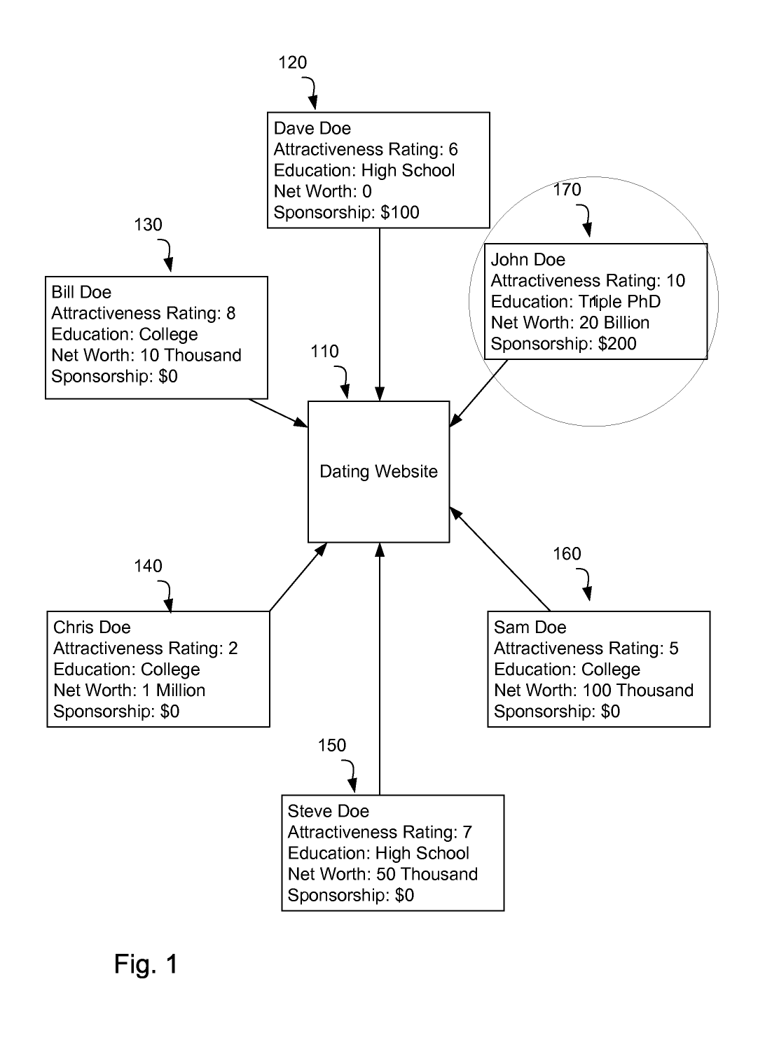

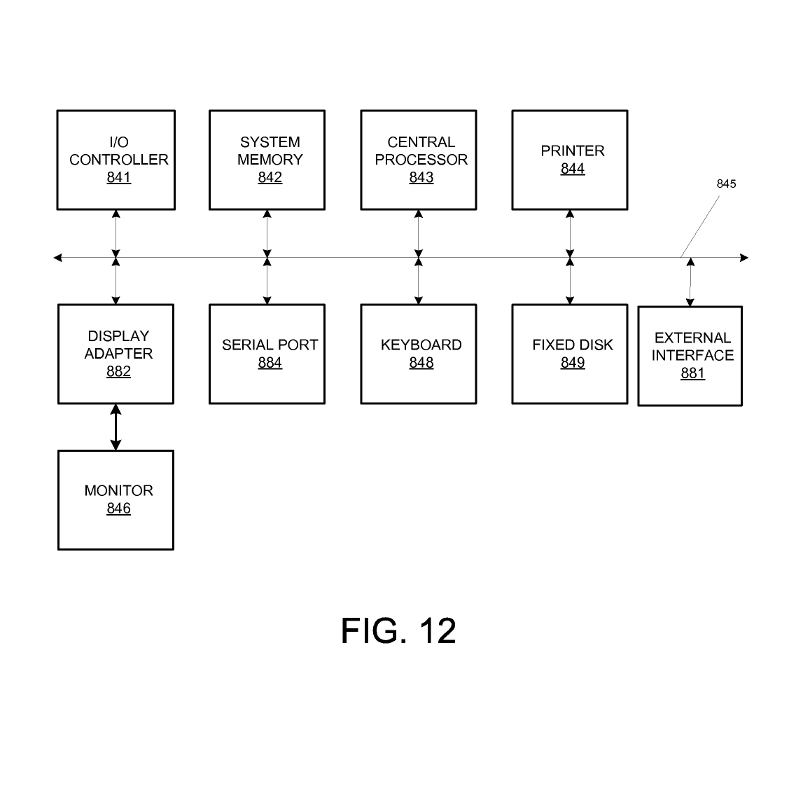

FIG. 1 depicts a block diagram of a dating website system, according to an embodiment. The dating website 110 may be hosted on a computing system as described in FIG. 12. The dating website 110 may provide facilities for users of the website to input information about themselves or other users (e.g., related to physical attractiveness). For example, user profiles 120, 130, 140, 150, 160, and 170 may contain information about each user. For purposes of explanation, the profiles depicted in FIG. 1 are very simplistic, containing only rudimentary information, such as a user's name, level of education, current net worth, and sponsorship. The user's profile may also contain information about the user's physical attractiveness.

On some dating websites, certain characteristics of the user may not be specified by the user himself, but rather are based on the collective wisdom of the entire community of users of the dating website. One characteristic that lends itself to this technique is the physical attractiveness rating. People tend to either over or under estimate their own physical attractiveness and a self-rating may be inaccurate. Some dating websites may allow the community of users to rate an individual user's attractiveness based on a photograph, or some other technique.

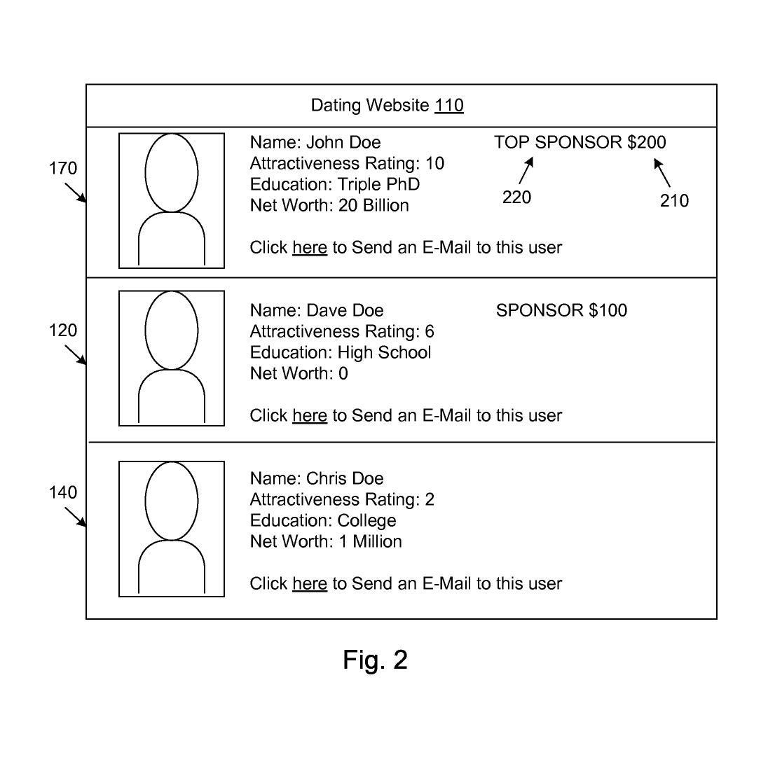

Some dating websites allow users to review each other's profile information, and based on actual or perceived similarities in profiles, allow the users to initiate contact with other users. In some cases, the dating website may allow a prospective suitor to specify desired criteria for a relationship partner, and the dating website will provide lists of users who match the criteria. In yet other cases, the dating website itself may select users who are felt to be a good match by the dating website. This will be described in further detail with respect to FIG. 2.

Some users' profiles may contain highly desirable characteristics that are sought after by large numbers of users of the dating website. For example, users with high physical attractiveness ratings will likely be in greater demand than those with lower ratings. Similar situations can arise from any number of other characteristics, such as level of education, or total net worth. In reviewing the profiles depicted in FIG. 1, it can be seen that the profile of John Doe 170 contains characteristics that would typically be more desirable than the other profiles. As shown in FIG. 1, John Doe 170 has a very high physical attractiveness rating, a very high education level, and a very high net worth. Any one of these characteristics individually may make John Doe 170 highly desirable to the members of the dating website.

Other users' profiles may contain less desirable characteristics that are not as sought after. For example, users with low physical attractiveness, education, or net worth may want to highlight their profile so that they are not passed up by potential suitors. In further reviewing the profiles depicted in FIG. 1, it can be seen that the profile of Dave Doe 120 and John Doe 170 each contain a sponsorship, showing that each of these profiles has been sponsored at a particular timeframe. Each of these profiles may be placed above other user profiles. Thus, even though Dave Doe 120 may have a low physical attractiveness rating, education level, or net worth, this profile can be highlighted to help make Dave Doe 120 more desirable to the members of the dating website.

FIG. 2 depicts browsing user profiles, according to an embodiment. On some dating websites, a user is able to browse the profiles of other users of the dating website. For example, the user may be able to view a photograph of the other users. In some cases, the profile information may be more detailed, including things such as attractiveness ratings, net worth, or education.

On some dating websites, the user is able to enter search criteria for the profiles of other users. For example, the user can search for other users with a net worth over a certain amount or who have greater than a certain level of education.

On yet other dating websites, the website itself may attempt to match the user with other users based on any number of factors. In essence, the website makes a determination of which users the website thinks will make good relationship partners for each other.

On some websites, a combination of some or all of these techniques may be utilized. FIG. 2 depicts an exemplary display of profiles that the user may be interested in. How this list of profiles is generated is relatively unimportant. For each profile 120, 140, 170 being browsed, the user may be given the opportunity to initiate contact with that user. For example, as depicted in FIG. 2, each profile may be associated with a link that allows the user to send an e-mail to the person associated with the displayed profile. It should be understood that the selection of an e-mail link is merely exemplary, and that any form of initiating communication could be utilized.

The listing of profiles may be sorted so that the users who provided sponsorship appear at the top of the list of search results on the website. The sponsorship amount 210 can appear with each of the user's profiles who provided a sponsorship amount when the list of search results was generated. In an embodiment, the user profiles may be displayed in descending order in relation to the amount of money that each user provided as sponsorship. For example, the profile with the highest sponsorship amount ($200) can be placed first, the profile with the next highest sponsorship amount ($100) can be placed second, and so on. The user profiles that have not provided a sponsorship amount can be placed below the sponsored profiles.

The user profiles may also be highlighted when the profile is associated with a sponsorship amount. For example, the highlighting 220 associated with profile 170 is with the words “TOP SPONSOR” and the highlighting associated with profile 120 is with the word “SPONSOR.” Profiles may be highlighted in any way that causes them to attract more attention, including shading, discoloring the profile background, flashing, using text with a different color, and the like.

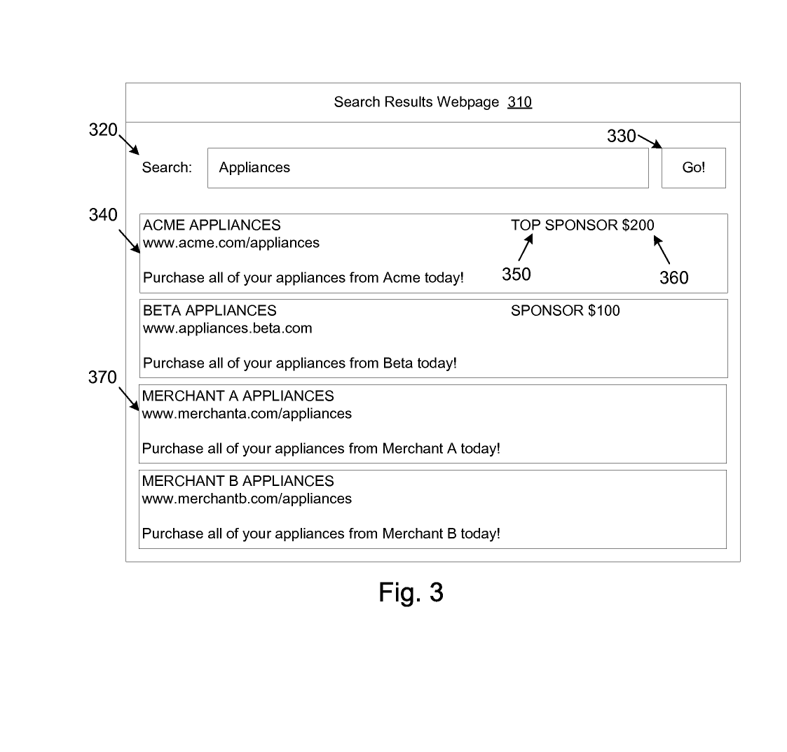

FIG. 3 depicts browsing search results on a search engine, according to an embodiment. On some search engines, a user can type a word or phrase into a dialog box. The user can provide a common word (e.g., “appliances”), a trademark (e.g., “Acme Appliances”), or any other combination of characters and numbers (e.g., “123 Main Street”). Once the user requests the search results from the user's search terms, the search results can be displayed to the user. The user can browse the list of search results on the website associated with the search engine.

The search results can be a mixture of sponsored and non-sponsored links to websites. The sponsored links can be highlighted and placed above other search results. For example, the browser may provide the search results by name, website address, advertising slogan, or any number of other items a user may want to see.

Any combination of these techniques may be utilized. FIG. 3 depicts an exemplary display of search results that the user may be interested in. The search results may be provided on a search results webpage 310. The search results webpage 310 can contain a dialog box 320 that the user can use to provide a search term, like “appliances,” and a button 330 to initiate the search.

Once the user initiates the search, a list of search results can be provided on the webpage associated with the search engine. The search results can include sponsored search results 340 and unsponsored search results 370. The sponsored search results 340 can be highlighted 350 (e.g., highlighted with the terms “top sponsor” and “sponsor”) and include the sponsorship amount 360 (e.g., $200, $100).

For example, the sponsored search results 340 can include an advertisement from Acme Appliances and Beta Appliances in relation to the search term “appliances” provided by the user. In the illustrated embodiment, the search engine provides the sponsored search results 340 above the unsponsored search results 370, even though both the sponsored search results 340 and unsponsored search results 370 relate to the term “appliances.” The search results webpage 310 can also display the sponsorship amount 360 provided by Acme Appliances and Beta Appliances in relation to this search term. In this example, the user could determine that Acme Appliances paid more for the sponsorship at the particular time of the search, so the user may believe that Acme Appliances is more dedicated or has more money to spend to advertise their product. In some embodiments, sponsorship amount is not considered when ranking search results. According to these embodiments, sponsored search results 340 are not necessarily ranked above non-sponsored search results 370. Instead, the results are merely ranked relevant to the search query. However, according to these embodiments, the sponsorship amount is still displayed so that user can “see” how much companies paid for the advertisement.

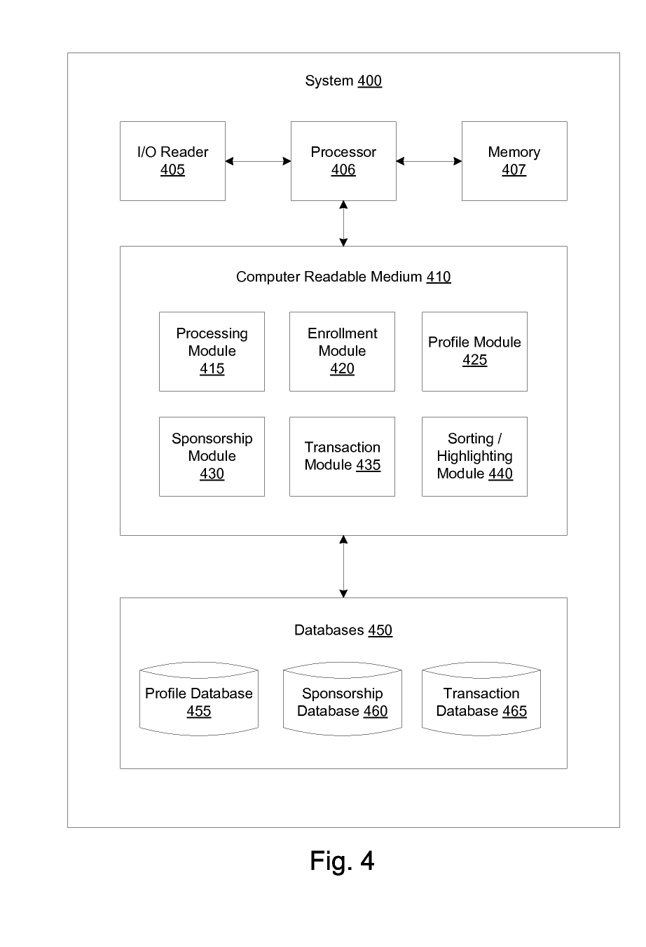

FIG. 4 depicts a block diagram of a system for implementing the dating website system, according to an embodiment. In this example, the system 400 includes an I/O reader 405, processor 406, memory 407, and a computer readable medium 410 that processes, enrolls, and manages the search results and associated sponsorship amounts. According to the illustrated embodiment, the computer readable medium 410 includes a processing module 415, enrollment module 420, profile module 425, sponsorship module 430, transaction module 435, and sorting/highlighting module 440. The computer readable medium 410 can also read/write data to databases 450. According to the illustrated embodiment, databases 450 may include a plurality of databases, including a profile database 455, a sponsorship database 460, and a transaction database 465.

According to some embodiments, the I/O reader 405 can be used to receive and transmit information with other devices or systems. The I/O reader 405, which can stand for an input/output reader, can receive or transmit information via any medium, including wired or wireless connections. The I/O reader 405 may be coupled with a processor 406.

According to some embodiments, the processor 406 can perform or execute steps of a method. For example, the processor 406 may be a central processing unit (CPU) to carry out instructions of a computer program by performing logical and input/output operations of the system. The processor 406 may be coupled with the I/O reader 405, memory 407, and computer readable medium 410.

According to some embodiments, the memory 407 can store a set of instructions that are executed by the processor. The memory 407 may be a physical device used to store computer programs or data on a temporary or permanent basis for use in the system 400. The memory 407 may be coupled with the processor 406.

According to some embodiments, the computer readable medium 410 can include non-transitory magnetic media such as magnetic disks, cards, and the like, capable of storing data in a format readable by the processor 406.

The computer readable medium 410 can contain a plurality of modules. Some of the modules may include a processing module 415, enrollment module 420, profile module 425, sponsorship module 430, transaction module 435, and sorting/highlighting module 440. It should be appreciated that the modules presented are provided for illustrative purposes and not intended to limit ways in which the system may be implemented.

According to some embodiments, a processing module 415 may be implemented to process, receive, and transmit messages. For example, the processing module 415 may process a top sponsor notification message by receiving a message from a user to sponsor a timeframe and transmitting the top sponsor notification message to a different user. The processing module may parse the information in the sponsorship message, extract the information from the message, and add the information to the sponsorship database 460 and/or transaction database 465. The processing module may also transmit information to a third party to initiate a payment transaction, which can, for example, charge or debit a sponsorship amount associated with a card number.

The processing module 415 may also be used to display a list of search results on a webpage associated with the social network or advertisements to display by a search engine. For example, the processing module 415 can receive the ordered and/or highlighted list of user profiles from the sorting/highlighting module 440 and transmit the list to the webpage to display.

According to some embodiments, an enrollment module 420 may be implemented to enroll a user in a social network or advertising service. The enrollment module can receive a request to enroll a user and/or contact the profile module 425 to initialize a profile for the user. The enrollment module 420 may generate a reminder for an existing user to notify them of the end of their enrollment with the social network or advertising service.

According to some embodiments, a profile module 425 may be implemented to initialize, update, and maintain a profile for a user. The profile module 425 can process the information received from the user, contact the profile database 455 to store the information in the database. For example, the profile module 425 may receive the user's name, birthdate, and education history as profile data. The profile module 425 can transmit the profile data to the profile database 455. The profile data may come from a website or a form provided by the user, third party, or another processing module. For example, when determining a user's attractiveness rating, the profile module may rely on input from other users to determine an average attractiveness rating. The average attractiveness rating can be determined by the profile module 425 and stored in the profile database 455.

In an embodiment, the profile module 425 may be used to invite users in the profile database 455 to pay a sponsorship amount to the social network administrator. The profile module 425 can query the profile database 455 to retrieve a list of users associated with the social network. The profile module can generate a message to each of the users of the social network to invite the users to pay a sponsorship amount. The sponsorship amount can be displayed in the user's profiles so that each user of the social network can see the sponsorship amount that the user in the social network is willing to pay to the social network administrator to attract other members to their profile. In an embodiment, the profile module 425 can provide the message to the processing module 415 so that the processing module can transmit the message to the users.

According to some embodiments, a sponsorship module 430 can be used to manage the sponsorship during a timeframe. For example, the sponsorship module 430 can receive information about a particular user's request to sponsor a timeframe. The information can include the sponsorship amount associated with a monetary value that the user is willing to pay during the timeframe to attract other users to his or her profile. The sponsorship module can update the sponsoring user's profile with the sponsorship amount, which can be stored in the profile database 455.

The sponsorship module 430 may identify a user as a top sponsor when the monetary value that the user is willing to pay is greater than any other sponsorship amount. The sponsorship module 430 can determine which user is the top sponsor if any portion of the timeframe is shared in common between the sponsoring users. In an illustration, a first user may pay $100 to become a top sponsor on December 1. When the sponsorship timeframe is 30 days, the first sponsor can be a top sponsor during December 1-30 unless another user sponsors a greater amount. The first timeframe may be December 1-30. On December 10, a second user may pay $200 to become a top sponsor, which is of course, greater than the first user's sponsorship amount. The second user's timeframe could be December 10 to January 8. The sponsorship module 430 can compare the second timeframe (12/10-1/8) with the first timeframe (12/1-12/30), and determine that the timeframes share at least a subset of time in common (12/10-12/30). Thus, the sponsorship module 430 can determine that the second user is the top sponsor starting on December 10 and remove the first user as the top sponsor on the same date.

The sponsorship module 430 can also generate a top sponsor notification message that can notify a user that they are the top sponsor, or notify a user that he or she is no longer a top sponsor. The top sponsor notification message can include the sponsorship amount from a user or an identification of the top sponsor. Using the illustration above, the top sponsor notification message can be generated by the sponsorship module 430 and transmitted to the first user to notify him or her that the second user provided a higher sponsorship amount (e.g., $200) and that the second user is now the top sponsor. The sponsorship module 430 may retrieve this information from the sponsorship database 460 and/or transaction database 465.

The sponsorship module 430 can also manage the sponsorship timeframe associated with a user. The sponsorship module can receive information about the sponsorship amount, date that the sponsorship amount was received by the sponsorship module, and the user who submitted the sponsorship amount. The sponsorship module can then determine the timeframe associated with the sponsorship by calculating the end date associated with the starting date, based on a predetermined timeframe decided by the social network administrator. For example, if the social network administrator determines that the timeframe is 30-days, the sponsorship module can add 30-days to the date the sponsorship was received (e.g., November 1), and store the end date of the timeframe in the sponsorship database (e.g., November 30).

The sponsorship module 430 can also determine the title associated with the user. For example, the sponsorship module can identify the title associated with a user's profile as a “top sponsor.” To determine the title, the sponsorship module can query or contact the sponsorship database 460 to determine if the sponsorship amount is the highest sponsorship amount at a particular time. If so, the sponsorship module can provide the “top sponsor” title to the user associated with the greatest sponsorship amount. If not, the sponsorship module can provide a “sponsor” title. The title can also be stored in the sponsorship database 460 by the sponsorship module, and used to later identify the user's profile as the top sponsor in the list of search results.

According to some embodiments, a transaction module 435 can initiate a payment transaction. The transaction module can receive information necessary to initiate the payment transaction when, for example, the user would like to pay a sponsorship amount. The user can provide a billing name, address, card number, expiration date, and any other information necessary to initiate the payment transaction. The transaction module 435 may generate a request to authorize the transaction, or receive a response that the transaction has been authorized. In an embodiment, the profile database may include billing information so that the transaction module can query the profile database to receive the billing information instead of receiving the information from the user. This may facilitate reoccurring transactions.

Historical transaction information may be stored in the transaction database 465 by the transaction module 435. The transaction module can receive the transaction information from the user when the transaction is initiated and maintain an account balance of the user within the system. This may simplify the billing process for the user and the social network administrator when users may frequently sponsor a new sponsorship amount during a time frame. For example, a payment transaction can be initiated a first time to create an account balance (e.g., a stipend amount larger than the sponsorship amount) and the account balance can be associated with the user. Once the user requests to sponsor a timeframe, the monetary value associated with the sponsorship amount can be deducted from the account balance. A historical record of the transactions can be stored in the transaction database 465.

According to some embodiments, a sorting/highlighting module 440 can be used to organize, sort, and highlight the profiles in the social network or the advertisements provided by the search engine. For example, the sorting/highlighting module 440 can receive a request to display a list of search results on a webpage associated with the social network. The sorting/highlighting module 440 can sort the order the first set of profiles that are associated with a sponsorship amount first and sort the order a second set of profiles that are not associated with a sponsorship amount last. The sorting/highlighting module 440 can also sort and/or highlight the first set of profiles by the sponsorship amount. For example, the profile associated with the highest sponsorship amount can be highlighted (e.g., by color, using the words “top sponsor”) and ordered first, the profile associated with the second highest sponsorship amount can highlighted (e.g., by color, using the word “sponsor”) and ordered second, and so on. After the sponsored profiles have been sorted and/or highlighted in the search results, the sorting/highlighting module 440 may place all other search results below the sponsored search results and provide the ordered list to the processing module 415 to transmit to the webpage.

The sorting/highlighting module 440 can also query the sponsorship database 460 to determine which profiles are associated with a sponsorship amount. The sorting/highlighting module 440 can use the information from the sponsorship database to determine the sort order of the profiles or advertisements, and which profiles or advertisements should be highlighted.

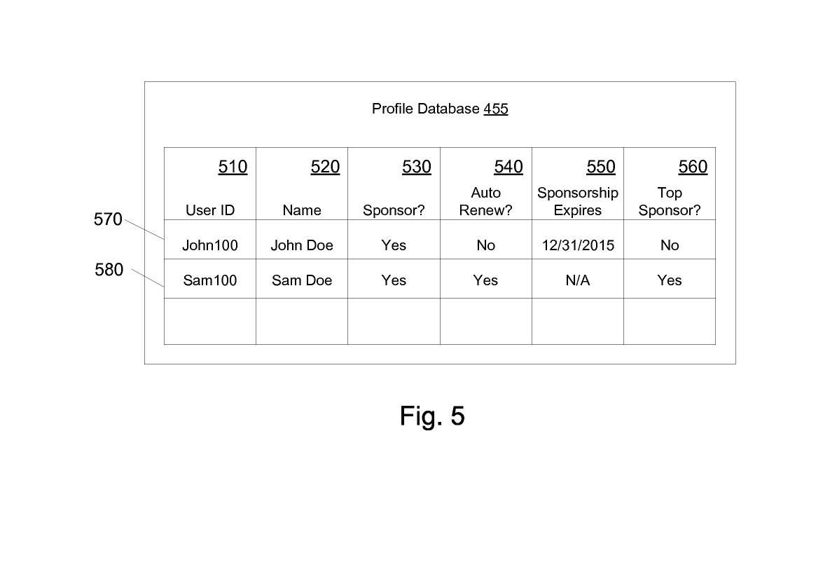

FIG. 5 depicts an exemplary screenshot of a profile database, according to an embodiment. The profile database 455 can store information about one or more user profiles, including a user identifier 510, user name 520, whether the user is a sponsor 530, whether the sponsorship amount is set to automatically renew for a subsequent term 540, the date that the sponsorship term expires 550, and whether the profile is a top sponsor 560. For example, as illustrated in row 570, information about the user named John Doe may be stored in the profile database. John Doe can have a user name (“John100”), a name (“John Doe”), data showing whether or not he is a sponsor (“Yes”), data showing whether or not the sponsorship amount is set to renew automatically for a subsequent term (“No”), the date that the sponsorship term expires (“Dec. 31, 2015”), and whether the profile is a top sponsor (“No”). As another example, as illustrated in row 580, information about the user named Sam Doe can also be stored in the profile database 455. Sam Doe can have a user name (“Sam100”), a name (“Sam Doe”), data showing whether or not he is a sponsor (“Yes”), data showing whether or not the sponsorship amount is set to renew automatically for a subsequent term (“Yes”), the date that the sponsorship term expires (“N/A”), and whether the profile is a top sponsor (“Yes”). Other information may be stored in relation to the profile as well, including the education level, attractiveness rating, net worth, and the like.

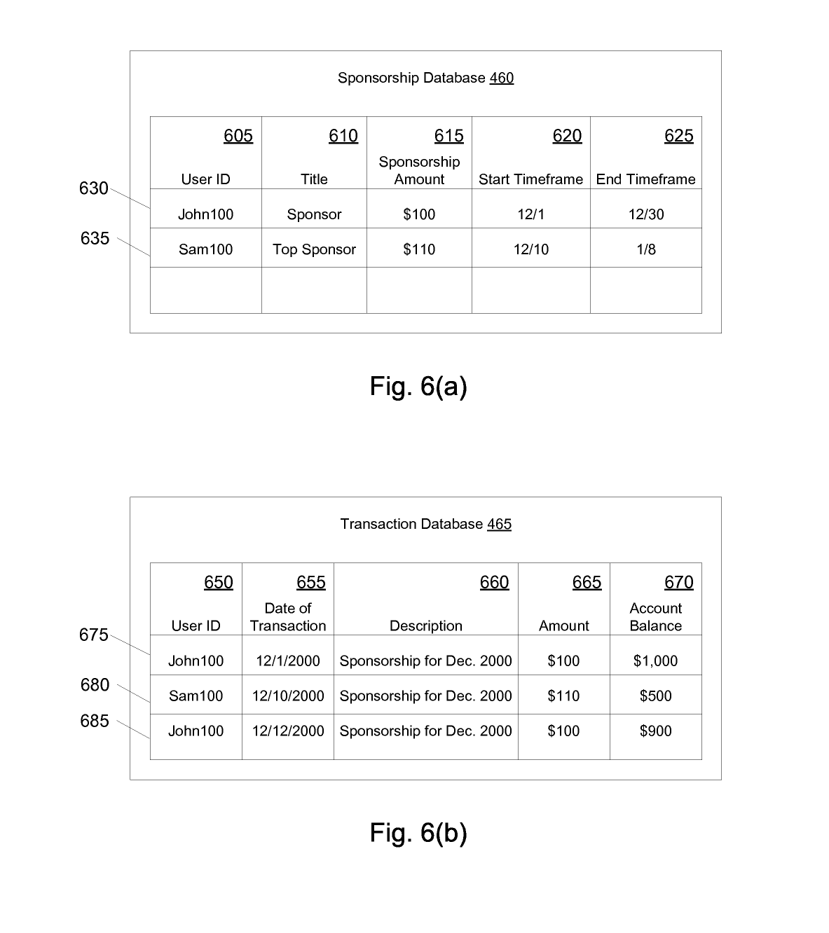

FIG. 6(a) depicts an exemplary screenshot of a sponsorship database, according to an embodiment. The sponsorship database 460 can store information about one or more sponsors, including the user identifier 605, title 610, sponsorship amount 615, the beginning or start of the timeframe for the sponsorship 620, and the end of the timeframe associated with the sponsorship 625. For example, as illustrated in row 630, sponsorship information about the user identifier John100 may be stored in the database. The profile can have a title (“Sponsor”), the sponsorship amount ($100), the beginning or start of the timeframe for the sponsorship (“12/1”), and the end of the timeframe associated with the sponsorship (“12/30”). As another example, as illustrated in row 635, information about the user identifier Sam100 can be stored in the sponsorship database 460. The profile can also have a title (“Top Sponsor”), sponsorship amount ($110), the beginning or start of the timeframe for the sponsorship (“12/10”), and the end of the timeframe associated with the sponsorship (“1/8”).

FIG. 6(b) depicts an exemplary screenshot of a transaction database, according to an embodiment. The transaction database 465 can store information about the transactions conducted by the social network, including sponsorship amounts and membership fees. For example, the transaction database 465 can store a user identifier 650, date of the transaction 655, description associated with the transaction 660, amount 665, and the account balance associated with the user identifier 670. The transaction database 465 may store historical transactions. For example, as illustrated in row 675, a record of a transaction conducted in association with user identifier John100 was conducted. The transaction can include the date of the transaction (“Dec. 1, 2000”), description (“Sponsorship for December 2000”), amount ($100), and account balance for John100 ($1,000). As another example, as illustrated in row 680, the user identifier Sam100 could have conducted a transaction as well. The transaction can include the date of the transaction (“Dec. 10, 2000”), description (“Sponsorship for December 2000”), amount ($110), and account balance for Sam100 ($500).

According to an embodiment, one or more modules may use the information stored in the transaction database to determine which user is a top sponsor. For example, if the sponsorship module queries the transaction database 465 with only rows 675 and 680, the sponsorship module could determine that the top sponsor for a timeframe is associated with the user identifier Sam100. The sponsorship module can update the title 610 in the sponsorship database for Sam100 to “Top Sponsor” and any other user identifier that provided a sponsorship amount to simply “Sponsor,” as shown in FIG. 6(a). Later in time, the transaction database 465 may be updated with another transaction, like row 685. As illustrated in row 685, user identifier John100 conducted another transaction on Dec. 12, 2000 for an additional $100. The sponsorship module can determine that as of Dec. 12, 2000, John100 has sponsored $200 by adding the $100 sponsorship amount from 12/1 and the $100 sponsorship amount from 12/12. The sponsorship module can also determine that Sam100 has sponsored $110 as of that date, which he submitted on 12/10. Since $200 is obviously greater than $100, John100 would become the new top sponsor. Using information stored in the transaction database, the sponsorship module can update the sponsorship database with a new title for John100 since he is now the top sponsor during a particular timeframe (e.g., 12/12 to 1/10). It should be appreciated that these and other examples are provided for illustrative purposes and not intended to limit ways in which the sponsorship amount by be calculated and/or displayed.

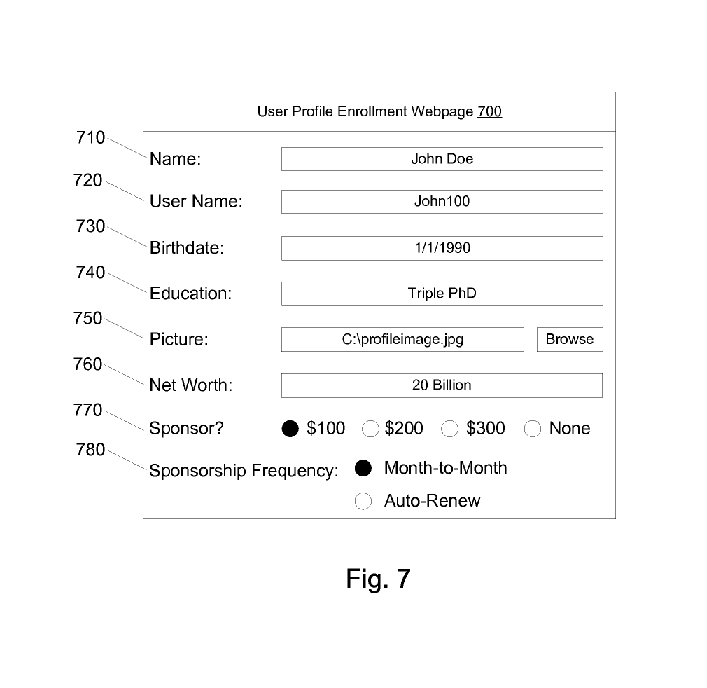

FIG. 7 depicts an exemplary screenshot of an enrollment webpage, according to an embodiment. The user profile enrollment webpage 700 can be a webpage or form to provide information about a user for the social network. For example, the user profile enrollment webpage can include text boxes for a user's name 710, user name 720, birthdate 730, education 740, picture 750 (e.g., a link to a picture stored on a user's computer), net worth 760, whether the user would like to sponsor a timeframe for a particular sponsorship amount 770, and the frequency of sponsorship desired 780. In a non-limiting example, the user may select the sponsorship amount and frequency of sponsorship by radio buttons by selecting a circle next to a desired amount (e.g., $100). The user profile enrollment webpage 700 can use the selection of the radio button to initiate a payment transaction for the desired amount. Information from the user profile enrollment webpage can be retrieved by modules associated with the computer readable medium 410 and stored in the databases 450.

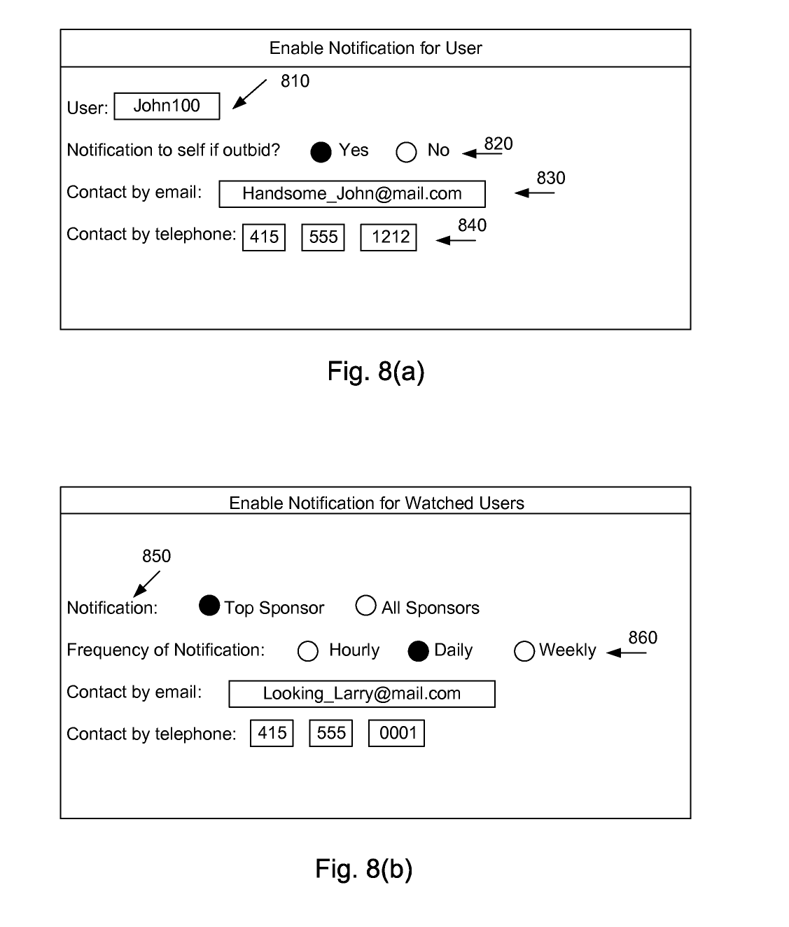

FIGS. 8(a-b) depict screenshots of enabling notifications, according to an embodiment. For example, notifications may be generated and transmitted to users.

According to an embodiment, a notification may be sent to a user using a webpage similar to the embodiment shown in FIG. 8(a). The user may be notified by a user identifier 810 for a particular notification 820. Notifications can be established for a variety of reasons. For example, if the user is a top sponsor and he or she would like to be notified if they are outbid, a notification can be established that notifies the user if they are outbid by another user and thus no longer the top sponsor. The notification may also be provided through various types of communication means, including email or telephone. If the user desires to be contacted by email, the email address can be provided in the email text box 830, or if the user desires to be contacted by telephone, the telephone number can be provided in the telephone text box 840.

According to an embodiment, a notification may be sent to users who are not participating in the sponsorship process, but would like to be notified when another user becomes a top sponsor user. The notification may be initiated using a webpage similar to the embodiment shown in FIG. 8(b). For example, if Pat Doe desires to know when Sam Doe becomes a top sponsor, Pat Doe may enable a notification associated with Sam Doe's sponsorship status. Pat Doe can choose to be notified about a top sponsor by selecting a top sponsor notification option 850, and the frequency of the notification desired 860. Email and telephone text boxes may also be provided.

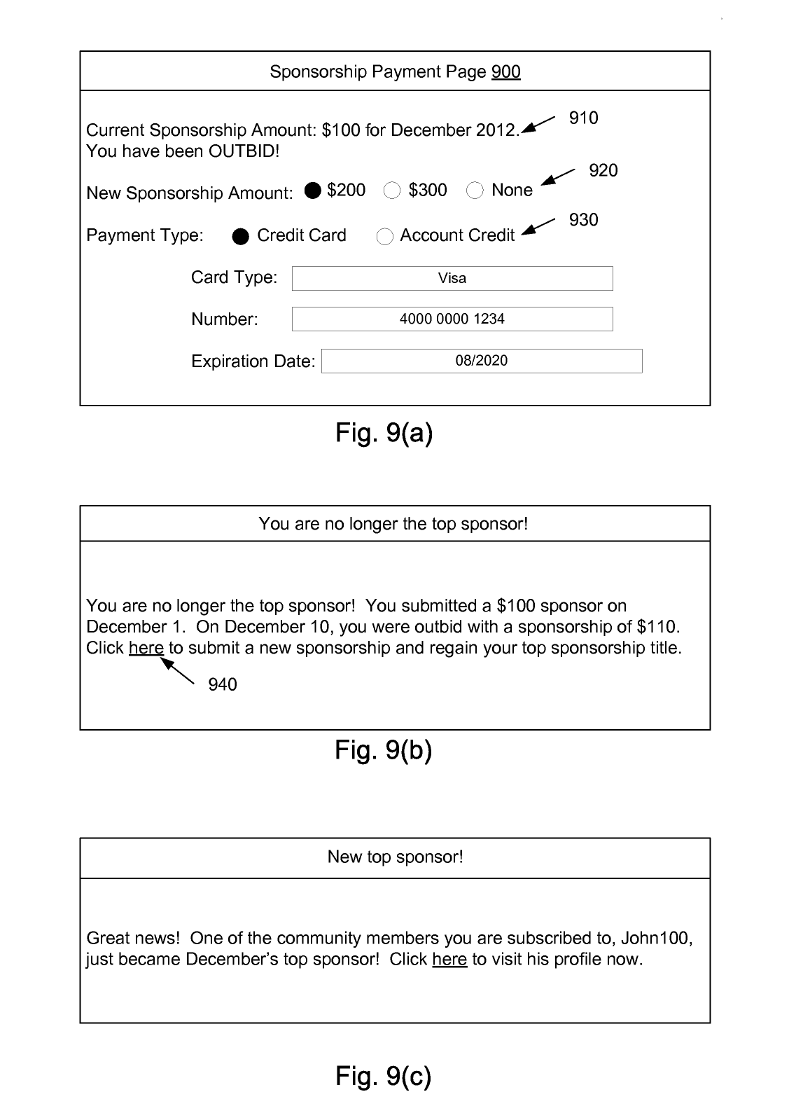

FIGS. 9(a-c) depict screenshots of receiving notifications after establishing a new top sponsor, according to an embodiment. A notification message of a new top sponsor may be provided with a sponsorship payment page 900, similar to an embodiment associated with the illustration in FIG. 9(a). For example, the user (e.g., user identifier John100) may have selected to receive a notification message if he was outbid as a top sponsor. The sponsorship payment page 900 can include a statement 910. The statement 910 can be used to inform the user of his status as a top sponsor and can include the sponsorship amount that the user paid, the date or timeframe that the user sponsored and any other relevant information. A portion of the sponsorship payment page may be dedicated to accepting a payment from the user, which the user may use to regain the top sponsor title. For example, the sponsorship payment page 900 can include a new sponsorship amount selection area 920 and a payment type area 930. The payment type area 930 can allow the user to select the type of payment the user would like to use to submit the sponsorship amount (e.g., credit card, account credit), the card type (e.g., Visa), the card number, expiration date, and other relevant information to initiate the payment transaction.

According to an embodiment, other notifications messages may be provided, including a notification message informing a former top sponsor that they are no longer a top sponsor, but without a payment portion, similar to the embodiment associated with the illustration in FIG. 9(b). The notification may provide a link 940 to a payment portion.

According to an embodiment, a user who is not involved in the notification process may also receive a notification when a new top sponsor has been chosen, similar to the embodiment associated with the illustration in FIG. 9(c). The notification can provide the name of the new top sponsor and a link to contact the user.

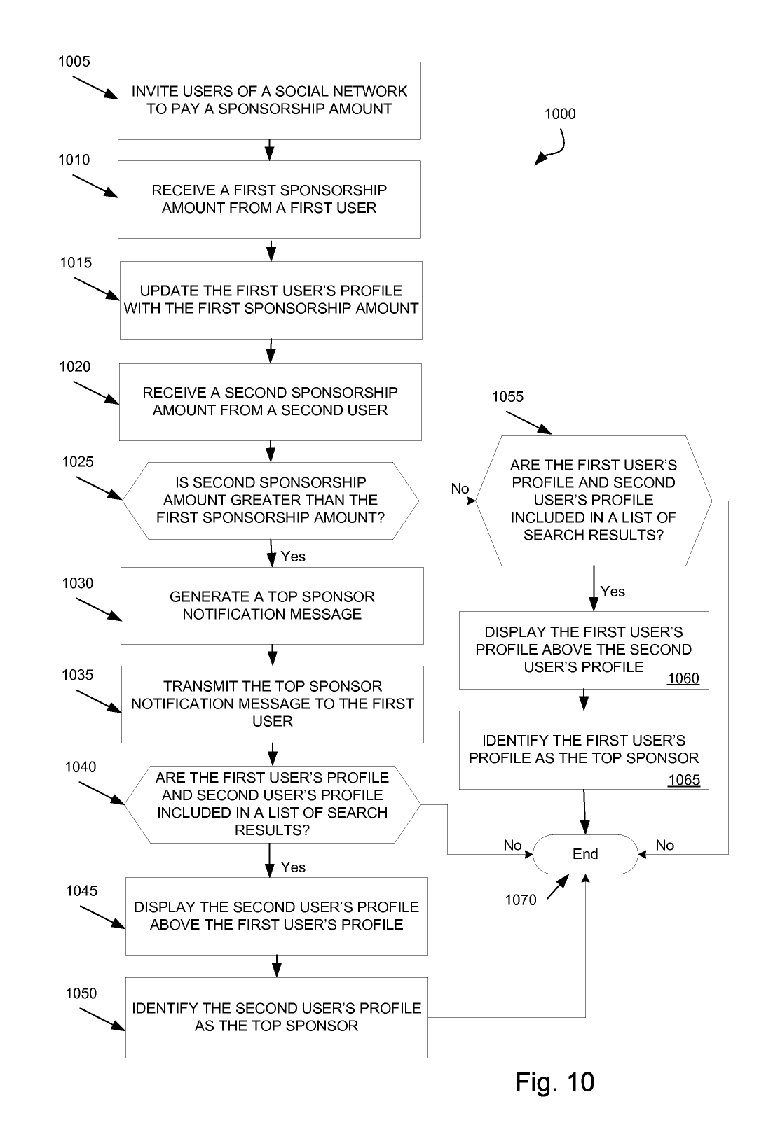

FIG. 10 depicts a high level flow chart of a sponsoring process associated with a social networking website, according to an embodiment. The method 1000 may be used to display a sponsorship amount in a list of search results on a webpage associated with a social network.

The method 1000 may begin at step 1005 by inviting users of the social network to pay a sponsorship amount. The sponsorship amount can be paid to a social network administrator. The sponsorship amount can be displayed in a user's profile so that other users of the social network can see the sponsorship amount that the user in the social network is willing to pay to the social network administrator to attract other users to their profile. The method may proceed to step 1010.

At step 1010, the method may receive a first sponsorship amount from a first user. For example, the first sponsorship amount can be associated with a first monetary value that the first member is willing to pay to the social network administrator to attract other users to the first user's profile. The sponsorship amount can be paid to sponsor a first timeframe. The method may proceed to step 1015.

At step 1015, the method may update the first user's profile with the first sponsorship amount. The method may proceed to step 1020.

At step 1020, the method can receive a second sponsorship amount from a second user. In an embodiment, the second sponsorship amount can be associated with a second monetary value that the second user is willing to pay to the social network administrator to attract other users to the second user's profile. The second sponsorship amount can be paid to sponsor a second timeframe. The second sponsorship amount can be greater than the first sponsorship amount, and the second timeframe can share at least a subset of time in common with the first timeframe. The method may proceed to step 1025.

At step 1025, the method may determine if the second sponsorship amount is greater than the first sponsorship amount. If so, the method can proceed to step 1030. If not, the method can proceed to step 1055. In an embodiment, the method can proceed to step 1040 (not shown).

At step 1030, the method can generate a top sponsor notification message. The top sponsor notification message can notify the first user that the second sponsorship amount is greater than the first sponsorship amount. The top sponsor notification message can also include the second sponsorship amount and identify the second user as a top sponsor. The method may proceed to step 1035.

At step 1035, the method can transmit the top sponsor notification message to the first user. The method may proceed to step 1040.

At step 1040, the method can determine if the first user's profile and the second user's profile are included in a list of search results. If so, the method can proceed to step 1045. If not, the method can proceed to step 1070.

At step 1045, the method can display the second user's profile above the first user's profile. When the profiles are displayed, the first user's profile can show the first sponsorship amount, and the second user's profile can show the second sponsorship amount. By displaying the second user's profile above the first user's profile, other users can be attracted to the second user's profile. In an embodiment, the method can display the second user's profile and first user's profile, but not necessarily one profile above the other (not shown). The method may proceed to step 1050.

At step 1050, the method can identify the second user as the top sponsor. For example, identifying the second user's profile as the top sponsor in the list of search results on the webpage associated with the social network can attract other users to the second user's profile. The method can proceed to step 1070.

At step 1055, the method can determine if the first user's profile and the second user's profile are included in a list of search results. If so, the method can proceed to step 1060. If not, the method can proceed to step 1070.

At step 1060, the method can display the first user's profile above the second user's profile. In an embodiment, the method can display the first user's profile and second user's profile, but not necessarily one profile above the other (not shown). The method can proceed to step 1065.

At step 1065, the method can identify the first user as the top sponsor. The method can proceed to step 1070.

At step 1070, the method can end.

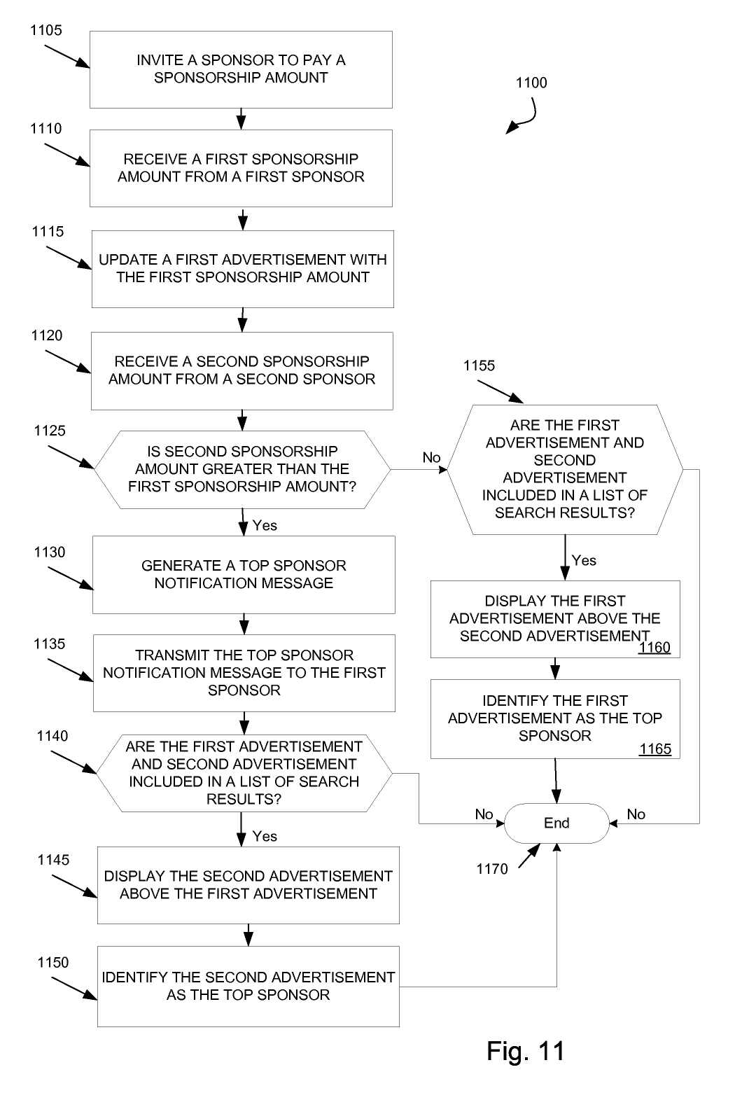

FIG. 11 depicts a high level flow chart of a sponsoring process associated with an advertisement on a website, according to an embodiment. The method 1100 may be used to display a sponsorship amount in an advertisement on a webpage.

The method 1100 may begin at step 1105 by inviting a sponsor to pay a sponsorship amount. The sponsorship amount can be paid to an administrator of the website. For example, in the context of an advertisement in a list of search results, the sponsorship amount can be paid to an administrator of the search engine. The sponsorship amount can be displayed with the advertisement so that users of the website can see the sponsorship amount that the sponsor is willing to pay to the administrator to attract users to their advertisement. The method may proceed to step 1110.

At step 1110, the method may receive a first sponsorship amount from a first sponsor. For example, the first sponsorship amount can be associated with a first monetary value that the first sponsor is willing to pay to the administrator to attract users to the first sponsor's advertisement. The sponsorship amount can be paid to sponsor a first timeframe. The method may proceed to step 1115.

At step 1115, the method may update the first sponsor's advertisement with the first sponsorship amount. The method may proceed to step 1120.

At step 1120, the method can receive a second sponsorship amount from a second sponsor. In an embodiment, the second sponsorship amount can be associated with a second monetary value that the second sponsor is willing to pay to the administrator to attract users to the second sponsor's advertisement. The second sponsorship amount can be paid to sponsor a second timeframe. The second sponsorship amount can be greater than the first sponsorship amount, and the second timeframe can share at least a subset of time in common with the first timeframe. The method may proceed to step 1125.

At step 1125, the method may determine if the second sponsorship amount is greater than the first sponsorship amount. If so, the method can proceed to step 1130. If not, the method can proceed to step 1155.

At step 1130, the method can generate a top sponsor notification message. The top sponsor notification message can notify the first sponsor that the second sponsorship amount is greater than the first sponsorship amount. The top sponsor notification message can also include the second sponsorship amount and identify the second sponsor as a top sponsor. The method may proceed to step 1135.

At step 1135, the method can transmit the top sponsor notification message to the first sponsor. The method may proceed to step 1140.

At step 1140, the method can determine if the first sponsor's advertisement and the second sponsor's advertisement are included in a list of search results. If so, the method can proceed to step 1145. If not, the method can proceed to step 1170.

At step 1145, the method can display the second sponsor's advertisement above the first sponsor's advertisement. When the advertisements are displayed, the first sponsor's advertisement can show the first sponsorship amount, and the second sponsor's advertisement can show the second sponsorship amount. By displaying the second sponsor's advertisement above the first sponsor's advertisement, users can be attracted to the second sponsor's advertisement. The method may proceed to step 1150.

At step 1150, the method can identify the second sponsor as the top sponsor. For example, identifying the second sponsor's advertisement as the top sponsor in the list of search results on the webpage can attract users to the second sponsor's advertisement. The method can proceed to step 1170.

At step 1155, the method can determine if the first sponsor's advertisement and the second sponsor's advertisement are included in a list of search results. If so, the method can proceed to step 1160. If not, the method can proceed to step 1170.

At step 1160, the method can display the first sponsor's advertisement above the second sponsor's advertisement. The method can proceed to step 1165.

At step 1165, the method can identify the first sponsor as the top sponsor. The method can proceed to step 1170.

At step 1170, the method can end.

FIG. 12 is a high level block diagram of a computer system that may be used to implement any of the entities or components (e.g., the dating website or the computers used by the users to access the dating website, etc.) described above may include one or more of the subsystems or components shown in FIG. 12, which is a block diagram of a computer apparatus. The subsystems shown in FIG. 12 are interconnected via a system bus 845. Additional subsystems such as a printer 844, keyboard 848, fixed disk 849, monitor 846, which is coupled to display adapter 882, and others are shown. Peripherals and input/output (I/O) devices, which couple to I/O controller 841, can be connected to the computer system by any number of means known in the art, such as serial port 884. For example, serial port 884 or external interface 881 can be used to connect the computer apparatus to a wide area network such as the Internet, a mouse input device, or a scanner. The interconnection via system bus allows the central processor 843 to communicate with each subsystem and to control the execution of instructions from system memory 842 or the fixed disk 849, as well as the exchange of information between subsystems. The system memory 842 and/or the fixed disk 849 may embody a computer readable medium. The computer readable medium may be non-transitory, such as in the form of the fixed disk, and embody thereon a set of instructions which when executed by the computer cause the computer to execute the methods of the invention described above.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. A method of displaying a sponsorship amount in a list of search results on a webpage associated with a social network, the method comprising:
inviting users of the social network to pay the sponsorship amount to a social network administrator, the sponsorship amount to be displayed in users' profiles so that each user of the social network can see the sponsorship amount that the users in the social network are willing to pay to the social network administrator to attract other users to their profile;
receiving from a first user of the social network a first sponsorship amount, wherein the first sponsorship amount is associated with a first monetary value that the first user is willing to pay to the social network administrator during a first timeframe to attract other users to the first user's profile;
updating the first user's profile with the first sponsorship amount;
receiving from a second user of the social network a second sponsorship amount, wherein the second sponsorship amount is associated with a second monetary value that the second user is willing to pay to the social network administrator during a second timeframe to attract other users to the second user's profile, wherein the second sponsorship amount is greater than the first sponsorship amount, and wherein the second timeframe shares at least a subset of time in common with the first timeframe;
updating the second user's profile with the second sponsorship amount;
generating a top sponsor notification message that will notify the first user that the second sponsorship amount is greater than the first sponsorship amount, wherein the top sponsor notification message includes the second sponsorship amount, and wherein the top sponsor notification message identifies the second user as a top sponsor;
transmitting the top sponsor notification message to the first user;
when the first user's profile and second user's profile are included in the list of search results on the webpage associated with the social network, displaying the second user's profile above the first user's profile, wherein the first user's profile shows the first sponsorship amount, wherein the second user's profile shows the second sponsorship amount, and wherein displaying the second user's profile above the first user's profile attracts other users to the second user's profile; and
identifying the second user's profile as the top sponsor in the list of search results on the webpage associated with the social network.

2. The method of claim 1 wherein the first timeframe and the second timeframe are one month.

3. The method of claim 1 further comprising:
inviting users of the social network to become reoccurring sponsors so that the sponsorship amount will be received from the user without a subsequent invitation to the user to pay the sponsorship amount.

4. The method of claim 1 further comprising:
initiating a first payment transaction for the first monetary value associated with the first sponsorship amount; and
initiating a second payment transaction for the second monetary value associated with the second sponsorship amount.

5. The method of claim 4 further comprising:
after the initiating a first payment transaction for the first monetary value, deducting the first monetary value associated with the first sponsorship amount from an account associated with the first user.

6. The method of claim 1 further comprising:
storing, in a database, the first sponsorship amount and the second sponsorship amount.

7. A system comprising a computer readable medium comprising code executable by a processor for implementing a method of displaying a sponsorship amount in a list of search results on a webpage associated with a social network, the method comprising:
inviting users of the social network to pay the sponsorship amount, the sponsorship amount to be displayed in users' profiles so that each user of the social network can see the sponsorship amount that the users in the social network are willing to pay to attract other users to their profile;
receiving from a first user of the social network a first sponsorship amount for a first timeframe;
updating the first user's profile with the first sponsorship amount;
receiving from a second user of the social network a second sponsorship amount for a second timeframe, wherein the second sponsorship amount is greater than the first sponsorship amount, and wherein the second timeframe shares at least a subset of time in common with the first timeframe;
updating the second user's profile with the second sponsorship amount;
when the first user's profile and second user's profile are included in the list of search results on the webpage associated with the social network, displaying the second user's profile and the first user's profile in the list of search results, wherein the first user's profile shows the first sponsorship amount, wherein the second user's profile shows the second sponsorship amount; and
identifying the second user's profile as a top sponsor in the list of search results on the webpage associated with the social network.

8. The system of claim 7, wherein the sponsorship amount is paid to a social network administrator.

9. The system of claim 8, wherein the first sponsorship amount is associated with a first monetary value that the first user is willing to pay to the social network administrator during the first timeframe to attract other users to the first user's profile, and wherein the second sponsorship amount is associated with a second monetary value that the second user is willing to pay to the social network administrator during the second timeframe to attract other users to the second user's profile.

10. The system of claim 7, wherein the second user's profile is displayed above the first user's profile, and wherein displaying the second user's profile above the first user's profile attracts other users to the second user's profile.

11. The system of claim 7 further comprising:
generating a top sponsor notification message that will notify the first user that the second sponsorship amount is greater than the first sponsorship amount, and wherein the top sponsor notification message identifies the second user as the top sponsor;
transmitting the top sponsor notification message to the first user.

12. The system of claim 11, wherein the top sponsor notification message includes the second sponsorship amount.

13. The system of claim 7, wherein the computer readable medium is coupled with a database, wherein the database stores the first sponsorship amount and the second sponsorship amount.

14. The system of claim 7, wherein the first timeframe and the second timeframe are one month.

15. A method of displaying a sponsorship amount in an advertisement on a webpage, the method comprising:
inviting sponsors to pay the sponsorship amount to a webpage administrator, the sponsorship amount to be displayed in the sponsor's advertisement so that each user of the webpage can see the sponsorship amount that sponsors are willing to pay to the webpage administrator to attract users to their advertisement;
receiving from a first sponsor a first sponsorship amount, wherein the first sponsorship amount is associated with a first monetary value that the first sponsor is willing to pay to the webpage administrator during a first timeframe to attract users to the first sponsor's advertisement;
updating the first sponsor's advertisement with the first sponsorship amount;
receiving from a second sponsor of the webpage a second sponsorship amount, wherein the second sponsorship amount is associated with a second monetary value that the second sponsor is willing to pay to the webpage administrator during a second timeframe to attract users to the second sponsor's advertisement, wherein the second sponsorship amount is greater than the first sponsorship amount, and wherein the second timeframe shares at least a subset of time in common with the first timeframe;
updating the second sponsor's advertisement with the second sponsorship amount;
generating a top sponsor notification message that will notify the first sponsor that the second sponsorship amount is greater than the first sponsorship amount, and wherein the top sponsor notification message identifies the second sponsor as a top sponsor;
transmitting the top sponsor notification message to the first sponsor;
when the first sponsor's advertisement and second sponsor's advertisement are included on the webpage, displaying the second sponsor's advertisement and the first sponsor's advertisement on the webpage, wherein the first sponsor's advertisement shows the first sponsorship amount, wherein the second sponsor's advertisement shows the second sponsorship amount; and
identifying the second sponsor's advertisement as the top sponsor on the webpage.

16. The method of claim 15, wherein the first sponsor's advertisement and second sponsor's advertisement are included in a list of search results on the webpage, and wherein the webpage is associated with a search engine.

17. The method of claim 15, wherein the second sponsor's advertisement is displayed above the first sponsor's advertisement, and wherein displaying the second sponsor's advertisement above the first sponsor's advertisement attracts users to the second sponsor's advertisement.

18. The method of claim 15 further comprising:
inviting sponsors to become reoccurring sponsors so that the sponsorship amount will be received from the sponsors without a subsequent invitation to pay the sponsorship amount.

19. The method of claim 15 further comprising:
initiating a first payment transaction for the first monetary value associated with the first sponsorship amount; and
initiating a second payment transaction for the second monetary value associated with the second sponsorship amount.

20. The method of claim 19 further comprising:
after the initiating a first payment transaction for the first monetary value, deducting the first monetary value associated with the first sponsorship amount from an account associated with the first sponsor.
